(19) United States
(12) Patent Application Publication
(10) Pub. No.: US 2015/0322277 A1
(43) Pub. Date: Nov. 12, 2015

(54) A METHOD FOR PREPARING POLYSTYRENE-STABILIZED NANOPARTICLES AND NANOSTRUCTURED SUBSTRATE SURFACES COMPRISING THE SAME AS WELL AS THE NANOSTRUCTURED SUBSTRATE SURFACES AS SUCH AND USES THEREOF

(71) Applicants: Joachim P. SPATZ, Stuttgart (DE); Simon ULLRICH, Stuttgart (DE); Christoph MORHARD, Ludwigsburg (DE); Stefan KUDERA, Stuttgart (DE)

(72) Inventors: Joachim P. SPATZ, Stuttgart (DE); Simon ULLRICH, Stuttgart (DE); Christoph MORHARD, Ludwigsburg (DE); Stefan KUDERA, Stuttgart (DE)

(21) Appl. No.: 14/376,424

(22) PCT Filed: Feb. 2, 2012
(86) PCT No.: PCT/EP2012/000470

§ 371 Date: Sep. 5, 2014

(51) Int. Cl. C09D 125/06; B05D 1/02; B05D 1/00; B05D 1/18

(52) U.S. Cl. CPC C09D 125/06; B05D 1/18; B05D 1/02; B05D 1/005

(57) ABSTRACT

The invention relates to a method for preparing a solution of micelles in an organic medium, which micelles comprise nanoparticles stabilized by a shell of at least one polymer having a terminal anchoring group which exhibits a high affinity to the surface of the nanoparticles. In a preferred embodiment, said method comprises at least the following steps: i) providing an aqueous solution/dispersion of nanoparticles, in particular metal or metal oxide nanoparticles, stabilized by a shell of a first stabilizing agent; ii) optionally displacing the molecules of the first stabilizing agent by molecules of a second stabilizing agent; iii) transferring the stabilized nanoparticles obtained in step i) or ii) into a solution/dispersion of anchoring group-terminated polymer in an unpolar organic solvent; iv) displacing the molecules of the first or second stabilizing agent by anchoring group-terminated polymer molecules having a higher affinity to the nanoparticles than the molecules of the first or second stabilizing agent; v) separating the polymer-stabilized nanoparticles from unbound polymer. Further aspects of the invention relate to the nanostructured substrate surfaces obtainable by said method as well as to the uses thereof.

### BACKGROUND

Periodically and aperiodically microstructured surfaces of a few micrometers to a few nanometers are used for a plurality of applications, especially electronic and optical components as well as sensors and in micro/nanotechnology. The production of such micro/nanostructured surfaces takes place by using known lithographic techniques suitably selected in accordance with the type of microstructure desired. Thus, e.g., structures in the nanometer range can be produced with electron-beam lithography and ion-beam lithography, and corresponding systems are commercially available. Furthermore, atomic-beam lithography allows large-surface periodic line patterns and different two-dimensional periodic structures to be produced by controlling the interactions of atomic beams with light masks.

However, since these methods have the disadvantage that they are not economically justifiable and/or supply no periodic structures in the nanometer range and/or can only be controlled by physical parameters and therefore require very expensive apparatuses, the so-called micellar block copolymer nanolithography was developed with which nanostructured surfaces with a periodicity in the lower nanometer range between 10 nm and 170 nm can be produced.

In this method, organic templates, e.g., block copolymers and graft copolymers that associate in suitable solvents to micellar core shell systems are used. These core shell structures serve to localize inorganic precursors from which inorganic particles with a controlled size can be deposited that are spatially separated from each other by the polymeric casing. The core shell systems or micelles can be applied as highly ordered monolayers on different substrates by simple deposition procedures such as spin coating or dip coating. By a gas-plasma process the inorganic precursor is reduced to elemental metal and at the same time the organic matrix is removed without residue as a result of which inorganic nanoparticles are fixed on the substrate in the arrangement in which they were positioned by the organic template. The size of the inorganic nanoparticles is determined by the weighed portion of a given inorganic precursor compound and the lateral distance between the particles through the structure, especially by the molecular weight of the organic matrix. As a result, the substrates have inorganic nanoclusters or nanoparticles, such as gold particles, in ordered periodic patterns corresponding to the respective core shell system used deposited on their surface. This micellar block copolymer nanolithography method (BCML) is described in, e.g., EP 1 786 572 B1 and Spatz et al. Macromolecules 1996, Vol. 29, pp 3220-3226.

However, usually spheric nanoparticles are produced with this method and it is difficult to create nanoparticles of having different shapes, e.g. rods, triangular, hexagonal, bone-shaped boot-shaped nanoparticles, pyramides, cuboids, or octapods, which may be preferable in some applications, e.g. sensor applications using plasmon resonance, surface enhanced raman spectroscopy (SERS), fluorescence probes on the surface of microspheres, by means of BCML.

It is already known to create nanostructured surfaces by two-dimensional self organization of polystyrene-capped gold nanoparticles (Yockell-Lelievre et al., Langmuir 2007 23 (5), 2843-2850) directly synthesized in an organic medium. This method, however, is not generally applicable, since there are a number of nanoparticles syntheses for different materials than gold or other than spherical shapes which are only possible in aqueous solvents.

Thus, the object underlying the present invention is to provide an alternative method for preparing nanoparticles and nanostructured surfaces comprising the same which is more versatile than BCML and other known techniques regarding the shape and/or material of the nanoparticles produced and to provide the corresponding nanostructured surfaces with an extended range of materials and shapes.

This object is achieved by providing the methods of claims 1, 2, 11, 13 and 20, and the nanostructured substrate surface according to claim 24. Preferred embodiments and additional aspects of the invention are the subject of further claims.

### DESCRIPTION OF THE INVENTION

The invention relates to methods for preparing a solution of micelles in an organic medium, which micelles comprise nanoparticles stabilized by a shell of at least one polymer having a terminal anchoring group which exhibits a high affinity to the surface of the nanoparticles.

In the embodiment according to claim 1, the claimed method comprises at least the following steps:
i) providing an aqueous solution/dispersion of nano-particles, in particular metal or metal oxide nanoparticles, stabilized by a shell of a first stabilizing agent;
ii) optionally displacing the molecules of the first stabilizing agent by molecules of a second stabilizing agent;
iii) transferring the stabilized nanoparticles obtained in step i) or ii) into a solution/dispersion of anchoring group-terminated polymer in an unpolar organic solvent;
iv) displacing the molecules of the first or second stabilizing agent by anchoring group-terminated polymer molecules having a higher affinity to the nanoparticles than the molecules of the first or second stabilizing agent;
v) separating the polymer-stabilized nanoparticles from unbound polymer.

In the more specific embodiment according to claim 2, the method for preparing a solution of micelles in an organic medium, which micelles comprise nanoparticles stabilized by a shell of at least one polymer having a terminal anchoring group which exhibits a high affinity to the surface of the nanoparticles, comprises the following steps:
a) providing an aqueous solution/dispersion of nanoparticles stabilized by a shell of a first stabilizing agent which is thermo-degradable at a temperature of below or equal to 250° C.;
b) separating the nanoparticles stabilized by a shell of the first stabilizing agent from the aqueous solution and suspending the separated stabilized nanoparticles in an aliphatic or olefinic compound with a terminal amine group (which is the second stabilizing agent) and having a boiling point above the degradation temperature of the first stabilizing agent;
c) heating the suspension obtained in step b) to the degradation temperature of the first stabilizing agent resulting in nanoparticles stabilized by a shell of the aliphatic or olefinic compound with a terminal amine group instead of a shell of the first stabilizing agent;
d) transferring the terminal amine-stabilized nanoparticles into a solution/dispersion of anchoring group-terminated polymer in an unpolar organic solvent;
e) displacing the molecules of the aliphatic or olefinic compound with a terminal amine group from the shell of the nanoparticles by anchoring group-terminated polymer molecules having a higher affinity to the nanoparticles than the molecules of the aliphatic or olefinic compound with a terminal amine group,
f) separating the polymer-stabilized nanoparticles from unbound polymer and the molecules of the aliphatic or olefinic compound with a terminal amine group.

An alternative embodiment of the invention for preparing a solution of micelles in an organic medium, which micelles comprise nanoparticles stabilized by a shell of at least one polymer having a terminal anchoring group which exhibits a high affinity to the surface of the nanoparticles, according to claim 11 comprises at least the following steps:
a) providing an aqueous solution/dispersion of nano-particles, in particular metal oxide nanoparticles, stabilized by a shell of a first stabilizing agent;
b) transferring the stabilized nanoparticles into a solution/dispersion of anchoring group-terminated polymer in an unpolar organic solvent;
c) displacing the molecules of the first stabilizing agent by anchoring group-terminated polymer molecules having a higher affinity to the nanoparticles than the molecules of the first stabilizing agent;
d) separating the polymer-stabilized nanoparticles from unbound polymer.

A further alternative method of the invention for preparing a solution of micelles in an organic medium, which micelles comprise nanoparticles stabilized by a shell of at least one polymer having a terminal anchoring group which exhibits a high affinity to the surface of the nanoparticles, according to claim 13 comprises at least the following steps:
a) providing nanoparticles, in particular metal oxide nanoparticles, coated with an anchoring layer with functional spacer groups in a polar organic medium;
b) contacting the coated nanoparticles with at least one polymer having a terminal anchoring group capable to react with the functional spacer groups of the coated nanoparticles, whereby a covalent bond linking the polymer with the nanoparticles is generated and a polymer shell around the nanoparticles is formed;
c) separating the polymer-stabilized nanoparticles from unbound polymer.

These methods differ from the BCML technique essentially in that a) no di-block-copolymer micelles are used, but micelles of a nanoparticle and a surrounding “single” polymer such as polystyrene functionalized with an anchoring group, and b) previously synthesized nanoparticles are applied instead of metal salts.

The material of the nanoparticles which can be produced by the methods of the invention is not especially limited. Typically, the material is selected from the group comprising metals, such as Au, Ag, Pd, Pt, Cu, Ni and mixtures thereof, metal oxides such as Al₂O₃, Fe₂O₃, Cu₂O, TiO₂, SiO₂, Si or other semiconductors. Metals, in particular gold, and metal oxides, M in particular Al₂O₃ and Fe₂O₃, are preferred for some applications.

The nanoparticles may have any shape, including spherical particles, and non-spherical particles, e.g. rods, triangular, hexagonal, bone-shaped boot-shaped nanoparticles, pyramides, cuboids, or octapods. The size of the particles may vary in a range of from 5 nm to 500 nm, more specifically from 10 nm to 200 nm.

The stabilizing and shell-forming polymer used in the present invention is not especially limited and may be any polymer having a terminal anchoring group which exhibits the required high affinity to the surface of the nanoparticles. The term “anchoring group having a high affinity to the surface of the nanoparticles”, as used herein, includes anchoring groups capable to form a covalent bond (or a bond with a strong covalent character) with molecules of the nanoparticles or functional groups thereon.

More specifically, the polymer functionalized by an anchoring group is selected from the group comprising polystyrene, polypyridine, polyolefines including polydienes, PMMA and other poly(meth)acrylates.

Typically, the functional anchoring group is a thiol, amine, COOH, ester or phosphine group.

For metal nanoparticles, in particular gold nanoparticles, the anchoring group is preferably a thiol group. In a specific and preferred embodiment, the anchoring group-terminated polymer is a thiol-terminated polystyrene.

Typically, the anchoring group-terminated polymer molecule has a length in the range of from 5 nm to 400 nm, more preferred in the range from 10 nm to 200 nm, in particular, in the range from 30 nm to 100 nm. For polystyrene polymers these lengths correspond to a number average molar mass Mn in the range from 10.000 g/mol to 100.000 g/mol, more specifically from 25.000 g/mol to 50.000 g/mol.

By using polymer molecules of different length it is possible to adjust the interparticle distances on a surface as desired. Thus, for example an ordered array of nanoparticles which is characterized by a predetermined interparticle distance in at least one area of said array and at least one predetermined interparticle distance different from the first interparticle distance in at least one other area of said array and wherein said predetermined interparticle distances are determined by the length of the anchoring group-terminated polymer molecules present in the respective areas, may be created.

The option to adjust the interparticle distances as desired is of particular interest if the resulting nanostructured surface is used as an etching mask.

In the method of the invention according to claim 1 and in particular claim 2, the first stabilizing agent may be a tenside, e.g. a polysorbate, a citrate or hexadecyl trimethyl-ammonium bromide (CTAB). This embodiment is preferred for metal nanoparticles.

In a specific embodiment of the method according to claim 2, the nanoparticles are metal nanoparticles and step a) of the claimed method comprises preparing an aqueous solution of stabilized metal nanoparticles by reducing an aqueous solution of an metal salt in the presence of a first stabilizing agent as mentioned above.

More specifically, the first stabilizing agent is hexadecyl trimethyl-ammonium bromide (CTAB) and the metal salt is an Au(III) salt, in particular HAuCl₄.

In a preferred embodiment of the invention, step b) of claim 2 comprises an ultrasound treatment. Typically, the ultrasound treatment is effected for a time period of 1-30 minutes, preferably 5-20 minutes.

Typically, the separation steps of the inventive method comprise at least one centrifugation step.

In a preferred embodiment of the invention, the heating in step c) of the method according to claim 2 is effected for a time period and at a temperature which is sufficient to enable reorganization of the particles resulting in a monodisperse size distribution.

In a more specific embodiment, step c) is effected in oleylamine for a time period in the range from 1-3 h and at a temperature in the range from 251-280° C., preferably about 260° C.

In step a) of the alternative embodiment of the invention according to claim 11, nanoparticles, in particular metal oxide nanoparticles, are provided as an aqueous solution/dispersion of nanoparticles, stabilized by a shell of a first stabilizing agent which is preferably water. The dispersion is preferably generated by adding the nanoparticles to an aqueous medium such as water and subsequently ultrasonicating the mixture (typically for a time period of 1-30 minutes, preferably 5-20 minutes).

The resulting dispersion is added to an unpolar solvent comprising a solution/dispersion of the anchoring-group terminated polymer. The unpolar solvent is preferably selected from the group comprising toluene, xylene, heptane, hexane, pentane or mixtures thereof. The aqueous dispersion of nanoparticles is mixed with the unpolar solvent comprising a solution/dispersion of the anchoring-group terminated polymer in an amount of from 0.1 to 5 volume percent of the unpolar solvent, preferably from 0.5 to 1 vol. %.

Subsequently, the resulting mixture is again ultrasonicated, typically for a time period of from 10 minutes to 2 hours, preferably from to 30 minutes to 1 h.

In a specific embodiment of this method, the metal oxide nanoparticles are Al₂O₃ nanoparticles, the first stabilizing agent is water and the anchoring group-terminated polymer is a COOH group-terminated polymer.

In step a) of the alternative method of the invention according to claim 13, nanoparticles, in particular metal oxide nanoparticles, are provided which are coated with an anchoring layer with functional spacer groups. The anchoring layer may be, e.g., a SiO₂, TiO₂, Fe₂O₃ or Au layer.

In particular for metal oxides, such as Al₂O₃, the anchoring layer may be a SiO₂ layer modified by silanization with amine-terminated or COOH-terminated silanes. Such coated metal oxide nanoparticles can be produced by methods known in the art (e.g. Sea-Fue Wang, Yung-Fu Hsu, Thomas C. K. Yang, Chia-Mei Chang, Yuhen Chen, Chi-Yuen Huang, Fu-Su Yen, Silica coating on ultrafine a-alumina particles, Materials Science and Engineering: A, Volume 395, Issues 1-2, 25 Mar. 2005, Pages 148-152) or are commercially available.

The coated metal oxide nanoparticles are provided in a polar, preferably slightly polar, solvent. The term “slightly polar” as used herein means a polarity index of more than 3.

Preferably, the slighly polar solvent is selected from the group comprising water, methanol, ethanol, propanol, other alcohols, or dichlormethane (DCM), Tetrahydrofuran (THF), dimethylformamide (DMF) or mixtures thereof.

In a specific embodiment, the metal oxide nanoparticles are Al₂O₃ nanoparticles coated with a SiO₂ layer silanized with NH₂- or COOH-terminated silanes and the polymer is a polymer with a terminal NH₂ or COOH group capable to react with the NH₂ or COOH groups of the coated Al₂O₃ nanoparticles, whereby a amide bond linking the polymer with the nanoparticles is generated and a polymer shell around the nanoparticles is formed.

The polymer-stabilized nanoparticles, e.g. obtained after step iv) of the method according to claim 1, step e) of the method according to claim 2, after step c) of the method according to claim 11, or after step b) of the method according to claim 13, are preferably separated from unbound polymer, e.g. by a centrifugation step, and resuspended in a desired organic D medium, preferably an unpolar organic medium.

More specifically, the unpolar organic medium is selected from the group comprising toluene, xylene, heptane, hexane, pentane or mixtures thereof.

The methods for preparing a micellar solution of nanoparticles in an organic medium as outlined above may be advantageously used for preparing a nanostructured substrate surface comprising an ordered array of polymer-stabilized nanoparticles thereon.

Such a method for preparing a nanostructured substrate surface may comprise steps i-v) of claim 1, steps a-f) of claim 2, steps a-d) of claim 11 or steps a-c) of claim 13 and further a step of coating a micellar solution of nanoparticles obtained in step v) of claim 1, step f) of claim 2, step d) of claim 11 or step c) of claim 13 onto a substrate surface and drying.

Alternatively, a micellar solution of polymer-stabilized nanoparticles produced by any other method may also be coated onto a substrate surface and dried.

The coating may be effected by any conventional technique, for example comprising a dip coating, dip-pen coating, spin coating or spray coating step.

Since the nanoparticles have been previously synthesized (contrary to BCML, where only metal salts are used) complex steps such as a plasma treatment (as in BCML) are not necessary. If necessary the remaining polymer can be easily removed, e.g. by pyrolysis. The use of previously synthesized particles also allows for the use of other than spherical shapes (e.g. rods and other shapes as disclosed above).

In a further method for preparing a nanostructured substrate surface, a substrate surface comprising an ordered array of polymer-stabilized nanoparticles, e.g., the nanostructured surface obtained by the method of claim 20, is subjected to an etching step and the nanoparticles deposited on the substrate surface serve as an etching mask.

For the etching step, any suitable method of the prior art may be used. Preferably, the etching is effected by Low Pressure Reactive Ion etching with fluor-based chemistry. Suitable etching agents are e.g. CHF₃, SF₆ or mixtures thereof. Typically, etching times between 1 minute and 10 minutes (preferably between 2 and 5 minutes) are used.

A closely related aspect of the present invention relates to the nanostructured substrate surfaces obtainable by the methods as outlined above and comprising an ordered array of nanoparticles stabilized with a shell of at least one polymer having a terminal anchoring group which exhibits a high affinity to the surface of the nanoparticles.

The material of the substrate surface is not especially limited. Typically, the material is selected from the group comprising Si, SiO₂, ZnO, TiO₂, GaAs, GaP, GaInP, AlGaAs, Al₂O₃, indium tin oxide (ITO), diamond and glass.

Also, the material of the nanoparticles is not especially limited. Typically, the material is selected from the group comprising metals, such as Au, Ag, Pd, Pt, Cu, Ni and mixtures thereof, metal oxides such as Al₂O₃, Fe₂O₃, Cu₂O, TiO₂, SiO₂, Si or other semiconductors. Metals, in particular gold, and metal oxides, in particular Al₂O₃ and Fe₂O₃, are preferred for some applications.

The nanoparticles may have any shape, including spherical particles, and non-spherical particles, e.g. rods, triangular, hexagonal, bone-shaped boot-shaped nanoparticles, pyramides, cuboids, or octapods. The size of the particles may vary in a range of from 5 nm to 500 nm, more specifically from 10 nm to 200 nm.

The stabilizing and shell-forming polymer is not especially limited and may be any polymer having a terminal anchoring group which exhibits the required high affinity to the surface of the nanoparticles.

The term “anchoring group having a high affinity to the surface of the nanoparticles”, as used herein, includes anchoring groups which form a covalent bond or a bond with strong or predominantly covalent character with molecules of the nanoparticles or functional groups thereon.

More specifically, the polymer functionalized by the anchoring group is selected from the group comprising polystyrene, polypyridine, polyolefines including polydienes, PMMA and other poly(meth)acrylates.

Typically, the functional anchoring group is a thiol, amine, COOH, ester or phosphine group.

For metal nanoparticles, in particular gold nanoparticles, the anchoring group is preferably a thiol group.

In a specific and preferred embodiment, the anchoring group-terminated polymer is a thiol-terminated polystyrene. The gold nanoparticles are transiently stabilized in an organic solvent by a shell composed of molecules of the aliphatic or olefinic compound with a terminal amine group, preferably oleylamine. This oleylamine shell is then replaced by thiol-terminated polystyrene. The functional thiol-group of the polymer forms a bond with strong covalent character with the gold nanoparticles and the outward facing polystyrene serves as a “spacer” in a self-assembly process (see FIG. 1). The reaction is shifted to the side of the thiol as the gold-sulfur bond has a covalent character and is thus much more stable than the dative bond of the free electron pair of the amine. In a further step the oleylamine is successively removed in order to reach an almost complete replacement of the shell.

Typically, the anchoring group-terminated polymer molecule has a length in the range of from 5 nm to 400 nm, more preferred in the range from 10 nm to 200 nm, in particular, in the range from 30 nm to 100 nm.

By using polymer molecules of different length it is possible to adjust the interparticle distances on a substrate surface as desired. The option to adjust the interparticle distances as desired is of particular interest if the resulting nanostructured surface is used as an etching mask.

In a specific embodiment, the nanostructured substrate surface comprises an ordered array of metal oxide nanoparticles, in particular Al₂O₃ or Fe₂O₃nanoparticles.

More specifically, the nanostructured substrate surface comprises an ordered array of Al₂O₃ nanoparticles (coated by an anchoring layer or not) stabilized by a shell of NH₂ or COOH group-terminated polymer molecules, in particular polystyrene molecules.

In a specific embodiment, the nanostructured substrate surface comprises an ordered array of nanoparticles which is characterized by a predetermined interparticle distance in at least one area of said array and at least one predetermined interparticle distance different from the first interparticle distance in at least one other area of said array and wherein said predetermined interparticle distances are determined by the length of the anchoring group-terminated polymer molecules present in the respective areas.

In a preferred embodiment, the nanostructured substrate surface according is an antireflective surface, such as for “moth eyes”.

The nanostructured substrate surfaces of the invention are of interest for a wide variety of applications, in particular in the fields of optics, spectroscopy, chemical or biochemical sensing and analytics, imaging technology, catalysts, laser applications, endoscopes, biomimetic surfaces, biocompatible surfaces and implants, antibiotic surfaces and devices.

Thus a further aspect of the invention relates to a device, in particular an optical device, spectroscopic device or sensor device, or a catalyst, comprising these nanostructured substrate surfaces.

Specific embodiments of the invention relate to the use of these nanostructured surfaces or of the ordered array of nanoparticles provided thereon as an etching mask or as anchor points for proteins.

The invention is further illustrating by the following non-limiting Examples and Figures.

### FIGURES

FIG. 1. Schematic presentation of the successive shell replacement steps in an exemplary embodiment of the inventive method for preparing polymer-stabilized nanoparticles a) spherical nanoparticles; b) rod-shaped nanoparticles

FIG. 2. Electron micrographs of quasi-hexagonally ordered gold nanoparticles of different sizes with shells of polystyrene chains of various length on substrates

FIG. 3. Electron micrograph of gold nanoparticles deposited onto a substrate using BCML

FIG. 4. Electron micrograph of rod-shaped gold nanoparticles deposited onto a substrate using the method of the present invention

FIG. 5. Electron micrograph of Al₂O₃ nanoparticles prepared and deposited onto a substrate using the method of the present invention

FIG. 6. Electron micrograph of a nanostructured lens

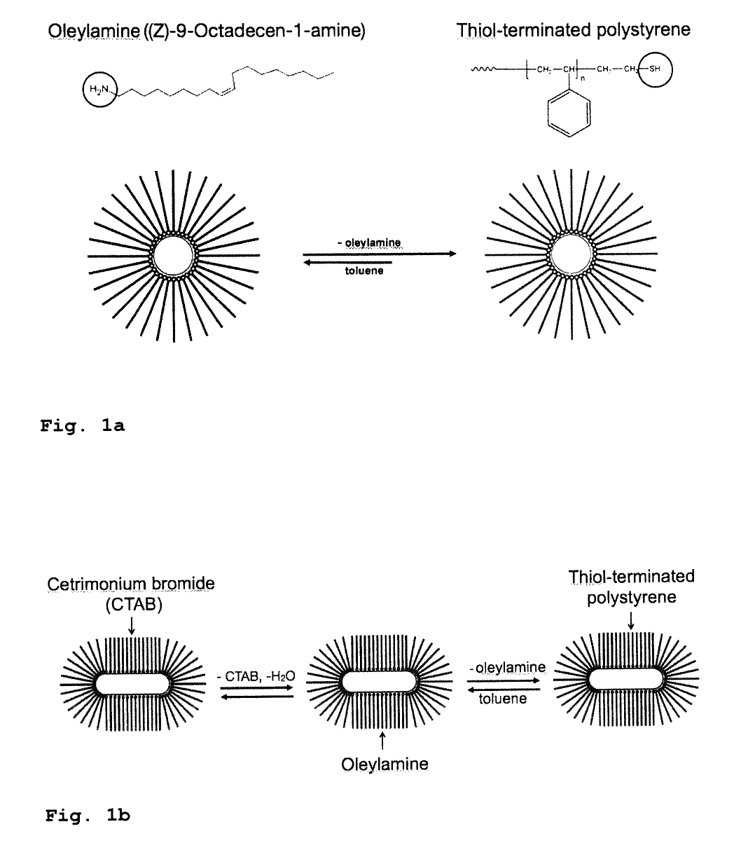

### EXAMPLE 1

### Preparation of Polystyrene-Stabilized Rod-Shaped Gold Nanoparticles

A) Synthesis of seed nanoparticles

2.5 ml of 0.1 M aqueous solution of cetyltrimethylammonium bromide (CTAB) were provided at a temperature of 40° C. in a 25 ml one-necked flask and 62.5 μl 0.01 M HAuCl₄ solution were added under heavy stirring. The slightly yellow HAuCl₄ solution turned orange/brownish on mixing with the CTAB solution. To the reaction mixture 150 μl of 0.1 M freshly prepared ice-cold NaBH4 solution were added and stirred for 2 minutes. Subsequently, the reaction mixture was maintained at 40° C. in a water bath for 1 h. The resulting gold seeds were used immediately for preparing rod-shaped gold nanoparticles in step B below.

B) synthesis of rod-shaped gold nanoparticles in aqueous solution

40 ml of 0.1 M aqueous solution of cetyltrimethylammonium bromide (CTAB) were provided at a temperature of 40° C. in a 100-ml one-necked flask and 2 ml 0.01 M HAuCl₄ solution were added under heavy stirring. The slightly yellow HAuCl₄ solution turned orange/brownish on mixing with the CTAB solution. To the reaction mixture 400 μl of 0.01 M AgNO₃ solution, 1.6 ml of 1 M HCl and 320 μl of 0.1 M L-ascorbic acid were added and stirred for 1 minute. The reaction mixture discolored and finally became completely clear. Subsequently, 80 μl of the solution of seed gold particles prepared in step A) above were added and stirred for 1 minute. The stirring (using a magnetic bar) was stopped and the reaction mixture maintained at 40° C. for 24 h. In the course of the first hours the reaction mixture turned reddish and gradually became darker. After the reaction was finished, the gold nanorods were centrifuged for 20 minutes at 15000 g and the supernatant was discarded. The gold nanorods were resuspended in 50 ml water. This washing step was repeated twice and a CTAB-stabilized solution of gold nanorods in water was obtained.

The synthesis of spherical gold nanoparticles can be effected by a similar protocol. In this case, no seed gold particles are used.

C) Preparation of oleylamine-stabilized gold nanorods

20 ml of the aqueous solution of gold nanorods obtained in step B) above were centrifuged at 15.000 g for 20 minutes in 2 15-ml centrifuge tubes and the supernatant was discarded. The gold nanoreds were resuspended in 10 ml oleylamine (boiling point 349° C.) at 260° C. in an ultrasound bath. The resulting solution was stirred at 260° C. for 2 h. When heated above 250° C., the CTAB shell around the particles decomposes completely into ammonia, oxides of nitrogen, carbon monoxide, carbon dioxide and hydrogen bromide. As the nanoparticles are suspended in oleylamine, the decomposing CTAB shell is directly replaced by an oleylamine shell and thus the nanoparticles are now solvable in organic solvents.

Since gold atoms are very mobile in such small particles even at these relatively low temperatures (260° C.), they reorganize themselves into to the energetically most favorable shape. Because of that a very monodisperse size distribution can be created.

The suspension was centrifuged at 15.000 g for 20 minutes. The supernatant was discarded and the pellet was resuspended in 5 ml of a solution comprising 5 mg/ml thiol-terminated polystyrene (Pt-CH₂Ch₂SH) in toluene in an ultrasound bath for 15 minutes. The solution was left standing for 24 h, once more methanol added, centrifuged and the pellet resuspended. This process was repeated 3 times in order to remove oleylamine nearly completely from the system and to replace the same by the polymer. The obtained product is a solution of micelles comprising the gold nanorods surrounded and stabilized by a shell of thiol-terminated polystyrene molecules. The concentration of the micelles can by adjusted by adding appropriate amounts of toluene. For the step of removing unbound polymer, methanol was added (typically in a proportion of 20-30%) to the micellar solution, centrifuged and the supernatant was discarded. This washing step was repeated twice. The resulting solution was dried in vacuo overnight and the pellet resuspended in anhydrous toluene.

### EXAMPLE 2

### Preparation and Characterization of Substrate Surfaces Nanostructured with Polystyrene-Stabilized Gold Nanoparticles

A solution of micelles comprising spherical or rod-shaped polystyrene-stabilized gold nanoparticles in toluene, for example prepared as detailed in EXAMPLE 1, was applied onto a substrate surface by means of a classical coating technology such as dip coating or spin coating and dried. In a typical protocol for spin coating, 20-30 μl solution were applied to 4 cm² surface at a speed of 2000 rpm, 1 minute.

Electron micrographs of various nanostructured surfaces obtained with this technique were taken (using a Zeiss Gemini 55 Ultra electron microscope) and compared with a nano-structured surface obtained by BCML.

FIG. 2 shows electron micrographs of quasi-hexagonally ordered gold nanoparticles on substrates (the scale is the same for all images). For this purpose polystyrene chains of various lengths were used. The distance on the left column corresponds to about 25 nm, the distance in the right column is about 50 nm. It is also visible that the method works with nanoparticles of different sizes.

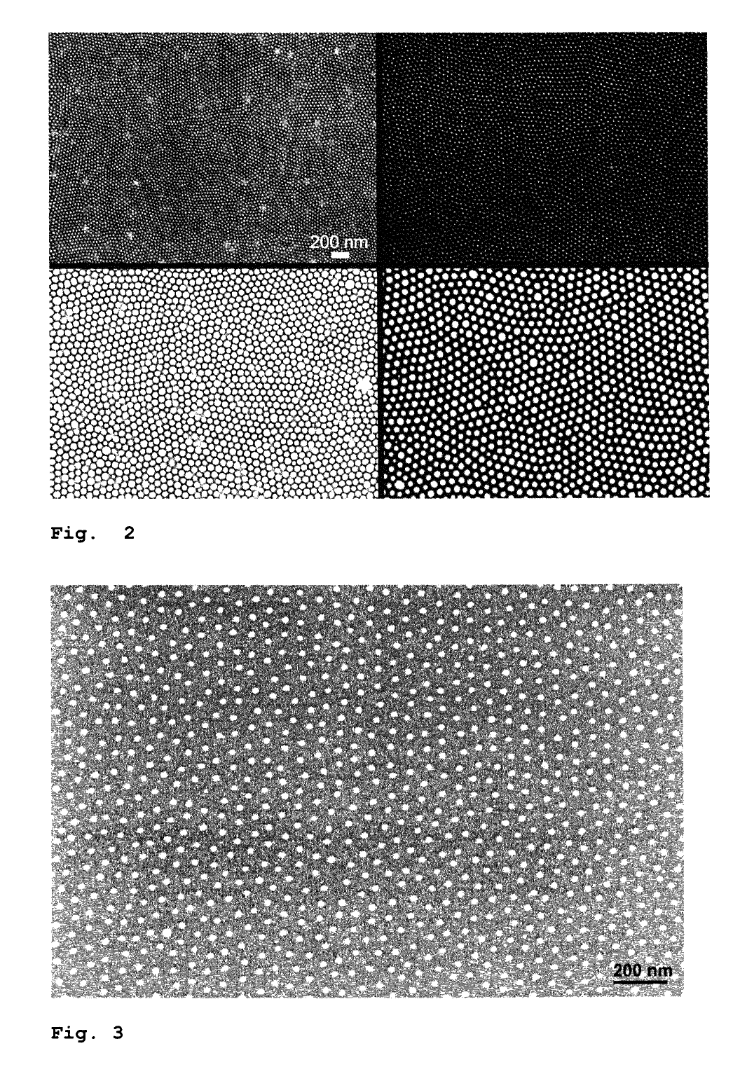

FIG. 3 shows an electron micrograph of nanoparticles which have been deposited onto a substrate using BCML. The similarity with FIG. 2 (top right) is clearly visible.

FIG. 4 shows an electron micrograph of rod-shaped nanoparticles, which have been applied onto the substrate with the above described method. The orientation of each rod is more or less randomly, but the existing inter-particle distance and the lack of agglomerations are clearly visible.

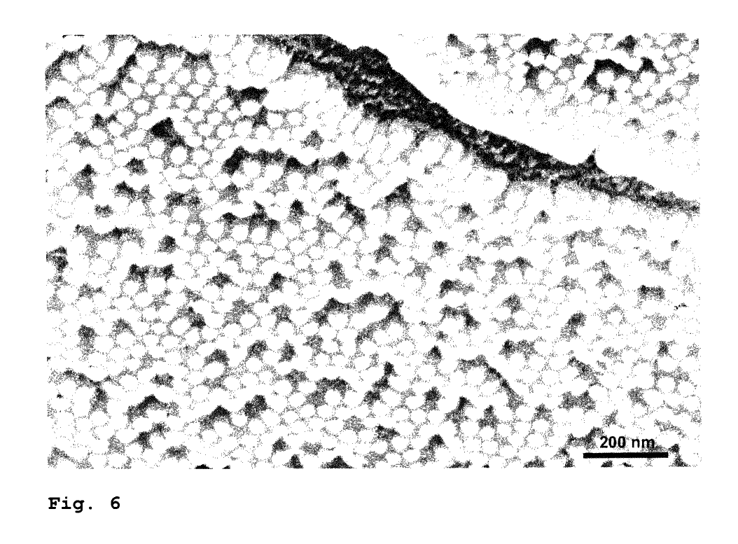

FIG. 6 shows an electron micrograph of a nanostructured lens (d=25.4 mm; f=50 mm; material: BK7. Plasmalab 80 from Oxford Plasma). In this case a gold nanoparticle array, which has been prepared with the previously described method, has been used as an etching mask.

Etching protocol:
Step 1:

SF₆-O₂: flow 30:20(sccm)

pressure: 70 mTorr

RF power: 250 W

ICP power: 100 W

t: 70 s
Step 2:

CHF₃: flow 40 (sccm)

pressure: 70 mTorr

RF power: 100 W

ICP power: 50 W

t: 20 s

T: 20° C.

Repeat step 1 and step 2 for 5 sucessive times

### EXAMPLE 3

### Preparation of Al₂O3 Nanoparticles Stabilized with COOH-Terminated Polystyrene

Al₂O₃-nanoparticles are functionalized via a thin SiO₂-shell layer and a NH2 terminated silane (commercially available). They are suspended in H₂O. Afterwards they are transferred into a solvent mixture of tetrahydrofuran (THF)/dichlormethane (DCM) or THF/TCM (trichlormethane). THF is miscible with water and polar enough to allow for to the dispersion of the Al₂O₃ nanoparticles. The addition of DCM or TCM allows for an amide binding to occur which is important later. After adding the Al₂O₃ nanoparticles to the mixture, it is ultrasonicated. Afterwards COOH-functionalized polystyrene is added and the whole solution is again ultrasonicated. An amide binding between the functional NH₂ group surrounding the Al₂O₃ sphere and the COOH-terminated polystyrene will occur. Therefore the nanoparticles will be surrounded by a protecting polystyrene polymer shell. Afterwards the suspension is centrifuged. The supernatant is discarded and the pellet is resuspended in toluene.

### EXAMPLE 4

### Preparation and Characterization of Substrate Surfaces Nanostructured with Uncoated Al₂O3 Nanoparticles Stabilized with COOH-Terminated Polystyrene

Al₂O₃ nanoparticles are dispersed in H₂O (10 mg/ml) via a 10 minute ultrasonication step. Afterwards 150 μL of the Al₂O₃/H₂O dispersion are transferred into a 3 ml mixture of toluene and COOH functionalized polystyrene (Mn: 96×10³ g/mol, Mw/Mn:1.07 (with Mw being the weight average molar mass); 3 mg/ml) and ultrasonicated again for 2 h. Due to the high surface area of the H₂O/toluene emulsion the Al₂O₃ particles are eventually transferred from the water phase into the organic phase. The COOH group of the polystyrene in the organic phase acts as an anchor group to the Al₂O₃ nanoparticles and therefore the nanoparticles are surrounded by an polystyrene shell. Afterwards the suspension is centrifuged (10.000 g, 20minutes). The supernatant is discarded and the pellet is resuspended in toluene. The resulting solution is spincoated (4000 rpm, 50 μL, 1 minute) onto a glass slide. The resulting structures are imaged in an REM.

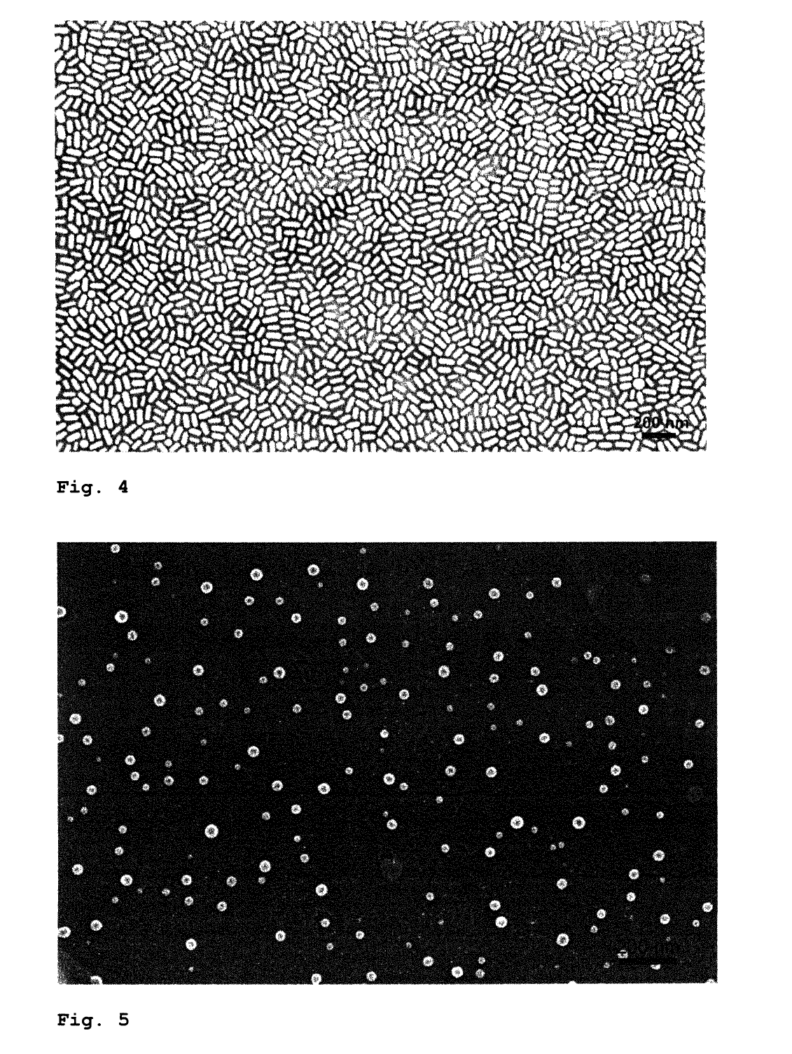

FIG. 5 shows an electron micrograph of Al₂O3 nanoparticles which have been prepared and applied onto the substrate with the above described method. The orientation of each particle is more or less randomly, but the existing inter-particle distance and the lack of agglomerations are clearly visible.

1. A method for preparing a solution of micelles in an organic medium, which micelles comprise nanoparticles stabilized by a shell of at least one polymer having a terminal anchoring group which exhibits a high affinity to the surface of the nanoparticles, and which method comprises at least the following steps:
i) providing an aqueous solution/dispersion of nanoparticles stabilized by a shell of a first stabilizing agent;
ii) optionally displacing molecules of the first stabilizing agent by molecules of a second stabilizing agent;
iii) transferring stabilized nanoparticles obtained in step i) or ii) into a solution/dispersion of anchoring group-terminated polymer in a nonpolar organic solvent;
iv) displacing the molecules of the first or second stabilizing agent by anchoring group-terminated polymer molecules having a higher affinity to the nanoparticles than the molecules of the first or second stabilizing agent; and
v) separating polymer-stabilized nanoparticles from step iv) from unbound polymer.

2. The method according to claim 1, wherein the first stabilizing agent is thermo-degradable at a temperature of below or equal to 250° C., and the step of displacing molecules of the first stabilizing agent is mandatory and comprises the following steps:
a) separating the nanoparticles stabilized by the shell of the first stabilizing agent from the aqueous solution and suspending the separated stabilized nanoparticles in an aliphatic or olefinic compound with a terminal amine group and having a boiling point above the degradation temperature of the first stabilizing agent;
heating the dispersion obtained in step a) to the degradation temperature of the first stabilizing agent resulting in nanoparticles stabilized by a shell of the aliphatic or olefinic compound with a terminal amine group instead of a shell of the first stabilizing agent.

3. The method according to claim 1, wherein the nanoparticles comprise a material selected from the group of Au, Ag, Pd, Pt, Cu, Ni and mixtures thereof, Al₂O₃, Fe₂O₃, Cu₂O, TiO₂, SiO₂, and Si.

4. The method according to claim 1, wherein the first stabilizing agent is a tenside.

5. The method according to claim 1, further comprising at least one centrifugation step.

6. The method according to claim 2 to wherein the nanoparticles are metal nanoparticles and the aqueous solution/dispersion providing step comprises preparing an aqueous solution of stabilized metal nanoparticles by reducing an aqueous solution of a metal salt in the presence of the first stabilizing agent.

7. The method according to claim 6, wherein the first stabilizing agent is hexadecyl trimethyl-ammonium bromide (CTA) and the metal salt is an Au(III) salt.

8. The method according to claim 2, wherein step a) comprises an ultrasound treatment.

9. The method according to claim 2, wherein the heating in step b) is effected for a time period and at a temperature which are sufficient to enable reorganization of the particles resulting in a mono-disperse size distribution.

10. The method according to claim 9, wherein the transferring step is effected in oleylamine for a time period in a range from 1-3 h and at a temperature in a range from 251-280° C.

11. The method according to claim 1, wherein optional step ii) is not performed.

12. The method according to claim 11, wherein the metal oxide nanoparticles are Al₂O₃ nanoparticles, the first stabilizing agent is water and the anchoring group-terminated polymer is a COOH group-terminated polymer.

13. A method for preparing a solution of micelles in an organic medium, which micelles comprise nanoparticles stabilized by a shell of at least one polymer having a terminal anchoring group which exhibits a high affinity to the surface of the nanoparticles, and which method comprises the following steps:
a) providing nanoparticles, coated with an anchoring layer with functional spacer groups in a polar organic medium;
b) contacting the coated nanoparticles with at least one polymer having a terminal anchoring group capable to react with the functional spacer groups of the coated nanoparticles, whereby a covalent bond linking the at least one polymer with the nanoparticles is generated and a polymer shell around the nanoparticles is formed; and
c) separating polymer-stabilized nanoparticles from step b) from unbound polymer.

14. The method according to claim 13, wherein the nanoparticles are metal oxide nanoparticles coated with a SiO₂ layer silanized with NH₂- or COOH-terminated silanes and the at least one polymer is a polymer with a terminal NH₂ or COOH group capable to react with the NH₂ or COOH groups of the coated metal oxide nanoparticles, whereby an amide bond linking the at least one polymer with the nanoparticles is generated and a polymer shell around the nanoparticles is formed.

15. The method according to claim 13, wherein the at least one polymer is selected from the group consisting of polystyrene, polypyridine, and polyolefins.

16. The method according to claim 15, wherein the terminal anchoring group is a thiol, amine, COOH, ester or phosphine group.

17. The method according to claim 16, wherein the nanoparticles are metal nanoparticles, and the at least one polymer is a thiol-terminated polystyrene.

18. The method according to claim 13, wherein the at least one polymer has a length in a range of from 5 nm to 400 nm.

19. The method according to claim 13, wherein the particles are not spherical.

20. A method for preparing a nanostructured substrate surface comprising the steps i-v of claim 1, and a further step of coating a micellar solution of nanoparticles obtained in step v) onto a substrate surface and drying.

21. The method according to claim 20, wherein the coating comprises a dip coating, dip-pen coating, spin coating or spray coating step.

22. The method for preparing a nanostructured substrate surface according to claim 20, wherein the surface obtained after the further step of coating is subjected to an etching step and wherein the nanoparticles deposited on the substrate surface serve as an etching mask.

23. The method according to claim 22, wherein the substrate surface is selected from the group consisting of Si, SiO₂, ZnO, TiO₂, GaAs, GaP, GaInP, AlGaAs, Al₂O₃, indium tin oxide (ITO), diamond and glass.

24. A nanostructured substrate surface obtainable by the method according to claim 20 and comprising an ordered array of nanoparticles stabilized with a shell of at least one polymer having a terminal anchoring group which exhibits a high affinity to the surface of the nanoparticles.

25. The nanostructured substrate surface according to claim 24 which comprises an ordered array of metal oxide nanoparticles.

26. The nanostructured substrate surface according to claim 25 which comprises an ordered array of Al₂O₃ nanoparticles stabilized by a shell of NH₂ or COOH group-terminated polymer molecules.

27. The nanostructured substrate surface according to claim 24, wherein the at least one polymer is selected from the group consisting of polystyrene, polypyridine, and polyolefins.

28. The nanostructured substrate surface according to claim 24, wherein the anchoring group-terminated polymer molecule has a length in a range of from 5 nm to 400 nm.

29. The nanostructured substrate surface according to claim 24, wherein the ordered array of nanoparticles is characterized by a predetermined interparticle distance in at least one area of said array and at least one predetermined interparticle distance different from the first interparticle distance in at least one other area of said array and wherein said predetermined interparticle distances are determined by a length of the anchoring group-terminated polymer molecules present in the respective areas.

30. The nanostructured substrate surface according to claim 24 which is an antireflective surface.

31. A device comprising the nanostructured substrate surface according to claim 24, wherein the device is a member selected from the group consisting of an optical device, a spectroscopic device, a sensor device, an imaging device, a laser, an endoscope, a biomimetic device, a biocompatible device and an antibiotic device.

32. (canceled)

33. A method for etching a substrate, said method comprising applying as an etching mask to the substrate the nanostructured surface or ordered array of nanoparticles according to claim 24.

34. The method according to claim 13, wherein the at least one polymer is selected from the group consisting of polystyrene, polypyridine, and polyolefins.

35. The method according to claim 34, wherein the terminal anchoring group is a thiol, amine, COOH, ester or phosphine group.

36. The method according to claim 34, wherein the nanoparticles are metal nanoparticles, and the at least one polymer is a thiol-terminated polystyrene.

37. The method according to claim 13, wherein the particles are not spherical.
